(19) United States
(12) Patent Application Publication
(10) Pub. No.: US 2002/0100425 A1
(43) Pub. Date: Aug. 1, 2002

(54) Implant system for tracking and monitoring animals

(76) Inventors: James L. Meyers, Gainesville, FL (US); Jon K. West, Gainesville, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 10/040,736

(22) Filed: Jan. 4, 2002

Related U.S. Application Data
(60) Provisional application No. 60/259,752, filed on Jan. 4, 2001.

(51) Int. Cl. A01K 29/00

(52) U.S. Cl. 119/174

(57) ABSTRACT

The subject invention provides materials and methods for gathering and/or relaying information about animals. In a specific embodiment, the present invention provides an animal identification system in which a biologically compatible, implanted device serves to accurately identify the location of a live animal and, in the case of livestock, its carcass after slaughter. In a preferred embodiment of the subject invention, the device to be implanted is coated with a bioactive glass to make the device bioactively bond to soft tissue. The coatings may be, for example, sintered, glued, sprayed, plasma sprayed, formed as a composite in the base material of the device or mixed with binders to be painted onto the device.

### CROSS-REFERENCE TO RELATED APPLICATION

This application claims the benefit of U.S. Provisional Application No. 60/259,752, filed Jan. 4, 2001.

### BACKGROUND OF THE INVENTION

Various techniques and devices have been proposed and used for animal tracking and identification. The techniques of branding and tattooing of animals are well known. Animal markers such as ear tags and back tags have also been used for identification. In addition, coded markers or tags embedded under the hide or skin of the animal have been used.

The current methods for animal identification and tracking have significant disadvantages. For example, back and ear tags have limited life and can be rubbed off easily. In the case of livestock, additional labor is required at the slaughtering plant to transfer the identifying information before slaughter. The integrity of the identification can be compromised due to the potential loss of the tags from a live animal and the required transfer of information during slaughter.

Tattoos exhibit problems with legibility when improperly applied and are subject to duplication. Also, the identifying information can be lost during trimming/or skimming operations.

Ear notching is subject to duplication and subject to error because of notches improperly positioned in the ear. Also, older animals tend to develop torn ears, reducing the legibility of ear notching and ear tattoos.

There are many applications in which a transponder which can be carried by an animal for automatic identification of the animal would be useful. Typical uses including monitoring migratory patterns of wild animals for studying their habits, providing automatic identification of domestic animals, controlling automatic feeding devices and the like, and verifying their identity, e.g., in connection with racehorses, livestock, pets and companion animals. Automatically operated transponders would also be useful in connection with the monitoring of laboratory animals, for a wide variety of experimental purposes.

The prior art shows a number of transponders which provide identification of animals. See, for example, Fathauer U.S. Pat. No. 3,541,995 which shows a transponder which can be affixed to an animal's collar or the like for identifying it as belonging to a particular class. The Fathauer device is relatively large and bulky and not suitable for identification of wild animals.

U.S. Pat. No. 4,262,632 to inventors Hannon et al. teaches an electronic identification system for ruminant animals comprising a transmitter capsule precoded to broadcast a series of binary pulses peculiar to the animal, the transmitter capsule being designed by adjusting its specific gravity to reside permanently in the animal's second stomach or reticulum. The electronics are encapsulated in a housing of a material which can be accepted physiologically by the animal and yet not be attacked by other contents in the reticulum. In the preferred embodiment, the electronics and a weight are inserted in a glass housing and the capsule is then evacuated and sealed off. Quartz and fiberglass are mentioned as suitable materials for the housing.

U.S. Pat. No. 5,482,008 by inventors Stafford et al. teaches a bolus for administration to a ruminant animal and for retention in the rumen or reticulum of the animal, the bolus having an electronic identification device housed therein with an identification code and a permanent visual representation of the identification code on and/or within the bolus.

Particularly in connection with the tracking of the movements of wild animals, it is desirable that transponders be provided which are extremely small and which can be readily implanted in the animals. An implantable transponder offers the advantage that it is not susceptible to loss and does not impede the motion of the animal. Jefferts et al. U.S. Pat. No. 3,313,301 shows injection of a length of wire having magnetic properties into an animal by means of a syringe or generally similar device. See generally Jefferts et al. U.S. Pat. Nos. 3,128,744; 4,233,964; 3,820,545; and 3,545,405.

The presence of an animal having had a sliver of wire implanted therein can be detected automatically by an inductive coil or the like; however, the animal cannot be specifically identified in such an arrangement. Thus, it is not possible to track the movements of an individual animal, but only of a large number of them. Jefferts et al. U.S. Pat. No. 4,344,964 shows a similarly implantable tag which has grooves formed into its outer surface such that an individual animal can be identified by x-raying it and analyzing the groove pattern. This is obviously a very awkward system in use and does not lend itself readily to automatic monitoring of the movements of specific animals.

The prior art also includes transponders which provide an identification of the identity of a particular animal upon interrogation by an automatic interrogator device. Animal identification thus does not require operator intervention. See Hanton et al. U.S. Pat. No. 4,262,632 which shows a transponder for retention in the second stomach of a ruminant animal. Not only is the Hanton et al. transponder too large for convenient implantation by means of a syringe or an automatic machine such as shown in some of the Jefferts et al. patents, but it is physically too large to be implanted into a relatively small animal such as a fish, a laboratory mouse, or the like.

It will be appreciated by those of skill in the art that it is important that a transponder for animal identification be durable in service, and it is accordingly an object of the invention to provide a transponder which is durable and reliable in service over a period of years. Certain existing animal tracking products are “injected” beneath the skin (subdermally) and are basically free to migrate between the muscle and skin tissues. Some products (AVID, 2000) are glass encased and coated with a protein to help elicit an immune response so that the body forms fibrous encapsulation. This is seldom successful and when it does occur it does not totally immobilize the device.

Other products (HomeAgain®) utilize a porous polymer matrix cap at the end of the microchip encapsulated glass tube to encourage soft tissue ingrowth and a consequent immobilization of the device. While more successful, the device can and does still migrate subcutaneously and data retrieval is potentially lost if the scanner does not locate the microchip.

In view of the difficulties discussed above, an identification system for livestock which is easily applied and capable of accurate identification of both live animals and carcasses is desirable. In addition, it is desirable that the identification system be biologically compatible with the animals.

### BRIEF SUMMARY

The subject invention provides materials and methods for gathering and providing information about animals. In one embodiment, materials and methods of the subject invention can be for the purpose of studying migration patterns and the like, in which recordation of the movements of individual animals is possible and in which the data recording the movement of the individual animals can be compiled.

In another embodiment, the present invention provides a system for animal identification and more particularly a system is provided for electronically tagging and monitoring livestock and other animals.

In a specific embodiment, the present invention provides an animal identification and monitoring system in which a biologically compatible, implanted pellet serves to accurately identify the source of the live animal and in the case of livestock, its carcass after slaughter.

In a preferred embodiment of the subject invention, the device to be implanted is coated with melt derived bioactive glass or sol-gel derived bioactive glass (such as TC45 or KTC45 powders) to make the device bioactively bond to soft tissue. The coatings may be, for example, sintered, glued, sprayed, plasma sprayed, formed as a composite in the base material of the device or mixed with binders to be painted onto the device.

Another aspect of the subject invention pertains to the replacement of the glass tube of such implantable devices with a bioactive glass tube or a composite bioactive material. The material may be, for example, TC45 powder impregnated into a polymer or plastic.

### DETAILED DISCLOSURE

The subject invention provides materials and methods for collecting information about animals. In a specific embodiment, the subject invention provides a system for monitoring the movements of animals. Specifically exemplified herein is the use of devices which are implanted in the animal and which are capable of transmitting a signal or otherwise communicating information so that the position, movement, status and/or identity of the animal can be monitored. The status of the animal can include physiological activity and/or the detection of external parameters.

Thus, the device of the subject invention has a first component which can be detected remotely. “Remote detection” refers to detection of the first component from outside the body of an animal in which the first component is implanted. The first component preferably emits a communication signal which can be detected by an appropriate receiver. Communication signals and appropriate receivers are well known to those skilled in the art. The device of the subject invention can thus be readily used to identify, and monitor, the location of an animal.

The device of the subject invention can also be used to gather and/or relay information about the status of an animal. The “status” of the animal includes information about physiological activities as well as information about external parameters. “Physiological activities” include, but are not limited to, body temperature, heart rate, pregnancy status, hydration, presence of drugs or medications, presence of indicators of infection, and presence of indicators of non-infectious disease or illness. External parameters include radiation and sound.

A large number of devices, including assay devices, are known to those skilled in the art which can measure the activities and parameters of interest. Thus, chemical entities associated with infections, heart disease, diabetes, cancer, and other maladies can be identified by the implanted device using standard means, and the presence of said entities communicated to a remote receiver. Physical parameters such as sound, heart rate, breathing rate, temperature, and radiation can also be detected. The information can be stored and/or relayed.

Advantageously, the implantable devices of the subject invention comprise a bioactive glass compound which secures the device in a specific location in the animal. In a preferred embodiment, the device is coated with a bioactive glass and is implanted subdermally. The bioactive glass bonds with soft living tissue thereby securing the device at its subdermal location.

In one embodiment, the location of the animals can be monitored for the purpose of studying migration patterns and the like. In this embodiment, recordation of the movements of individual animals is possible and the data recording the movement of the individual animals can be compiled. The devices of the subject invention can also be used for tracking human location and movement. Such uses would be of particular interest for the military.

In another embodiment, the present invention provides a system for animal identification and more particularly a system is provided for electronically tagging and monitoring livestock using internal transponders.

In a specific embodiment, the present invention provides an animal identification system in which a biologically compatible, implanted pellet serves to accurately identify the source of the live animal and in the case of livestock, its carcass after slaughter.

Animals which can be monitored include livestock such as cattle, horses, goats, sheep, swine, poultry (chicken, geese, ducks, turkeys), buffalo, camel, donkeys, llamas, yaks, and fish; endangered animals such as African Elephant, Blue Whale, Red Wolf, tiger, and turtles; domesticated animals such as dogs, cats, rabbits, ferrets, guinea pigs, birds, fowl, doves and horses; and wild animals such as fish, birds, crocodiles, moles, gazelles, wild cats, wolves, and alligators.

In a preferred embodiment of the subject invention, the device to be implanted is coated with bioactive glass (such as TC45 or KTC45 powders) to make the device bioactively bond to soft tissue. The coatings may be sintered, glued, sprayed, plasma sprayed, formed as a composite in the base material of the device and mixed with binders to be painted onto the device.

Another aspect of the subject invention pertains to the replacement of the glass tube with a bioactive glass tube or a composite bioactive material (such as TC45 powder impregnated into a polymer or plastic).

A variety of bioactive glasses, glass-ceramics, and ceramics are known in the art and can be used according to the subject invention. These include bioactive glasses such as BIOGLASS and its formulations. Bioactive glasses both melt derived and sol-gel derived include, for example, those taught in U.S. Pat. Nos. 3,981,736; 4,131,597; 4,309,488; 4,613,516; 4,478,904; 4,676,796; 4,775,646; 4,851,046; 5,068,122; 5,074,916; 5,420,081; 5,429,996; 5,468,544; 5,458,636; 5,480,438; 5,486,598; 5,527,836; 5,554,501; 5,573,934; 5,605,713; 5,629,186; 5,643,789; 5,645,934; 5,676,720; 5,698,019; 5,721,049; 5,735,942; 5,762,950; 5,830,480; 5,834,008; 5,840,290; 5,861,176; 5,871,777; 5,874,101; 5,879,109; 5,891,233; 5,934,287; 5,964,745; 5,977,204; 5,981,412; 5,972,384; 6,010,713; 6,017,496; and 6,027,742. Each of these patents, as well as other patents and references cited herein, is hereby incorporated by reference in their entireties.

In one embodiment, the bioactive glass material used according to the subject invention has a composition (by percent weight) of 0-70% SiO₂, 0-40% CaO, 0-40% Na₂O, 0-40% K₂O, and 0-20% P₂O₅. Preferably, at least two of the listed compounds are present. An exemplary composition of bioactive glass has a composition (by percent weight) of 40-60% SiO₂, 10-30% CaO, 10-35% Na₂O, 2-8% P₂O₅, 0-25% CaF₂, and 0-10% Ba₂O₃. Another embodiment envisions the bioactive glass formulation to be (by percent weight) 45% SiO₂, 24.5% CaO, 24.5% Na₂O, and 6% P₂O₅. Methods of making a powder of bioactive glass are well known to those skilled in the art and include, for example grinding or pulverizing glass particles into a fine powder.

In one embodiment, the present invention provides an identification system for animals such as livestock which overcomes the disadvantages of the prior art by utilizing a biologically compatible implant or pellet suitable for implantation under the hide or skin to identify the source of the live animal and its carcass after slaughter. This invention also contemplates a device for implanting the identification pellet beneath the hide or skin of the animal. In addition, the implanting device can be furnished in a kit together with a plurality of identification pellets.

In a preferred embodiment, the devices used according to the subject invention may be either active or passive electronic devices. In one example the device is a transponder. Such devices are well known and readily used by those skilled in the art. In a specific embodiment, the electronic device is an electronic tracking device. The devices of the subject invention can, advantageously, comprise a microchip for storing and/or transmitting desired information. GPS technology can be readily used in conjunction with these devices for identifying locations accurately.

In one embodiment, the devices of the subject invention can be coated with Ca—Na—P silicate powder. This powder may be, for example, TC45<20 μm or TC45<710 μm. The material may also contain potassium.

A bioactive coating can be bonded to the devices of the subject invention by a thermal plastic or thermal-set adhesive. Epoxy, organic and inorganic polymer, and copolymer adhesives can be used to coat the devices with a bioactive glass.

In one embodiment of the subject invention, the bioactive glass coating can be bonded to the device via a dusting while the base material is softened. In a further embodiment, the coating is bonded to the device via a dusting while the base material is heated near its glass transition point, Tg. In yet, another embodiment, the coating is bonded to the device via a thermal sintering process or a plasma spraying. In a further embodiment, the bioactive powder can be mixed into a base material to form a composite.

The device may further comprise additional components such as antimicrobial or anti-inflammatory agents. Inorganic coatings which bind to bone can also be utilized.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

we claim:

1. A device for monitoring an animal wherein said device comprises a first component capable of being detected remotely, and wherein said device further comprises a bioactive compound which prevents or reduces the movement of the first component when said first component is implanted in an animal.

2. The device, according to claim 1, wherein the bioactive compound is formed as a composite with a base material.

3. The device, according to claim 1, wherein the bioactive compound is bioactive glass.

4. The device, according to claim 3, wherein the bioactive glass is a sol-gel derived or a melt-derived bioactive glass.

5. The device, according to claim 3, wherein the bioactive glass is TC45 powder or KTC45 powder.

6. The device, according to claim 3, wherein the bioactive glass comprises 0-70% SiO₂, 0-40% CaO, 0-40% Na₂O, 0-40% K₂O, and 0-20% P₂O₅, wherein at least two of the compounds are present.

7. The device, according to claim 6, wherein the bioactive glass comprises 45% SiO₂, 24.5% CaO, 24.5% Na₂O, and 6% P₂O₅.

8. The device, according to claim 3, wherein the bioactive glass comprises 40-60% SiO₂, 10-30% CaO, 10-35% Na₂O, 2-8% P₂O₅, 0-25% CaF₂, and 0-10% Ba₂O₃.

9. The device, according to claim 1, wherein the first component is an active or passive electronic device.

10. The device, according to claim 9, wherein said first component emits a signal identifying the location of the device.

11. The device, according to claim 9, wherein the first component is an internal transponder.

12. The device, according to claim 9, which comprises a microchip for storing or transmitting information.

13. The device, according to claim 1, wherein the device further comprises an antimicrobial agent.

14. The device, according to claim 1, wherein the device further comprises an antiinflammatory agent.

15. The device, according to claim 1, wherein said device, when implanted in an animal, detects physiological activity within the animal.

16. The device, according to claim 15, wherein said physiological activity is selected from the group consisting of body temperature, heart rate, pregnancy status, hydration, presence of drugs or medications, presence of indicators of infection, and presence of indicators of noninfectious disease or illness.

17. The device, according to claim 1, wherein said device, when implanted in an animal, detects one or more parameters originating external to the animal.

18. The device, according to claim 17, wherein said device detects a parameter selected from the group consisting of radiation and sound.

19. A method for monitoring an animal comprising receiving a communication signal from a device implanted in the animal wherein said device comprises a first component capable of being detected remotely, and wherein said device further comprises a bioactive compound which prevents or reduces the movement of the first component when the device is implanted in the animal.

20. The method, according to claim 19, further comprising implanting the device into an animal.

21. The method, according to claim 19, wherein the bioactive compound is a bioactive glass.

22. The method, according to claim 21, wherein the bioactive glass is sol-gel derived or melt-derived bioactive glass.

23. The method, according to claim 21, wherein the bioactive glass comprises 0-70% SiO₂, 0-40% CaO, 0-40% Na₂O, 0-40% K₂O, and 0-20% P₂O₅, wherein at least two of the compounds are present.

24. The method, according to claim 20, wherein the device is an active or passive electronic device further comprising a microchip for storing or transmitting information.

25. A system for monitoring an animal comprising:
a) an implantable device capable of being detected remotely, and wherein the said device further comprises a bioactive compound which prevents or reduces the movement of the device when the device is implanted in the animal; and
b) a second component for remotely detecting said first component.

26. The system according to claim 25, wherein the first component transmits a communication signal which provides information regarding the animal.

27. The system,according to claim 25, wherein the bioactive compound is a bioactive glass.

28.The system, according to claim 25, wherein the bioactive glass is sol-gel derived or melt-derived bioactive glass.
